(19) United States
(12) Patent Application Publication
(10) Pub. No.: US 2002/0182929 A1
(43) Pub. Date: Dec. 5, 2002

(54) Battery pack circuit board with a position-variable connector

(76) Inventors: Ju Nan Chang, Taipei Hsieng (TW); Shuen De Mau, Taipei Hsieng (TW)

Correspondence Address: BIRCH STEWART KOLASCH & BIRCH, PO BOX 747, FALLS CHURCH, VA, 22040-0747, US

(21) Appl. No.: 09/870,474

(22) Filed: Jun. 1, 2001

(51) Int. Cl. H01R 3/00

(52) U.S. Cl. 439/500

(57) ABSTRACT

A battery pack circuit board electrically connected to a battery and an electronic device. The circuit board contains a connector and an output terminal. The connector connects to the corresponding connector on the electronic device. The output terminal is installed on the battery pack circuit board with a position-variable connector. The invention is characterized in that it further contains a connecting means that electrically connects to the output terminal and the connector to change the relative positions between the connector and the output terminal.

### BACKGROUND OF THE INVENTION

1. Field of Invention

The invention relates to a battery pack circuit board and, in particular, to a battery pack circuit board with a position-variable connector and the corresponding method for changing the position of the connector.

2. Related Art

With advances in technologies, the dimensions and weights of electronic devices are decreasing. Therefore, the designs of the accessories for electronic devices have to be modified accordingly. Taking a battery pack as an example, to match the positions of the connectors in different electronic devices, different battery packs are usually needed for different electronic devices.

With reference to FIG. 1, the battery pack mainly contains a battery cell 11 and a circuit board 12 for controlling voltages and currents. The battery cell 11 and the circuit board 12 are electrically connected together via wires 13. The circuit board 12 contains an output terminal 14 and a connector 15. It should be emphasized that the output terminal and the connector are located in the same place in the prior art and the connector 15 has to match the connector on the electronic device to be connected to it.

However, sometimes the dimension or shape of the electronic device varies but it uses essentially the same circuit board. To match the connector with a new position in this case, the same battery pack circuit board becomes incompatible and has to be redesigned. Since redesigning and rewiring the circuit board not only take time and effort, but also requires further justification and verification by retailers, both the cost and stability will encounter negative influences in the development of new electronic devices.

### SUMMARY OF THE INVENTION

In view of the foregoing, an objective of the invention is to provide a battery pack circuit board with a position-variable connector and a method for changing the position of the connector of the battery pack circuit board so that different electronic devices can use the same battery pack circuit board. Thus, the invention can save a lot of time when developing new electronic devices.

Another objective of the invention is to provide a battery pack circuit board with a position-variable connector and a method for changing the position of the connector of the battery pack circuit board and thus different electronic devices can use the same battery pack circuit board, so that only the shell of a new model electronic device needs to be modified, lowering the development cost.

A further objective of the invention is to provide a battery pack circuit board with a position-variable connector and a method for changing the position of the connector of the battery pack circuit board to control the quality of the circuit board can be controlled and its stability and reliability increased.

In accordance with the above objectives, the disclosed battery pack circuit board with a position-variable connector electrically connects to a battery cell and an electronic device. The battery pack circuit board contains a connector and an output terminal. The connector connects to a corresponding connector on the electronic device. The output terminal is located on the battery pack circuit board so as to output the electric power of the battery cell on the circuit board. The invention is characterized in that a connecting means is provided to electrically connect the output terminal and the connector, so that the relative positions of the connector to the output terminal are variable.

The invention also provides a method for changing the position of the connector of the battery pack circuit board, which first determines the location of the connector on the circuit board, then designs a connecting means at a proper position relative to the output terminal and the connector on the circuit board, and finally connects the output terminal and the connector using the connecting means.

The disclosed method uses a connecting means to connect the output terminal and the connector on the connecting circuit board so that different electronic devices can use the same battery pack circuit board, thus saving a lot of time in developing new electronic devices.

The disclosed method uses a connecting means to connect the output terminal and the connector on the connecting circuit board so that different electronic devices can use the same battery pack circuit board, thus lowering development costs.

The disclosed method can control the quality of circuit boards, greatly increasing the stability and reliability of circuit boards.

### BRIEF DESCRIPTION OF THE DRAWINGS

The invention will become more fully understood from the detailed description given in the herein below illustration only, and thus are not limitative of the invention, and wherein:

FIG. 1 is a schematic view showing a structure of a conventional battery pack circuit board with a position-fixed connector;

FIG. 2(A) is a schematic view showing a preferred embodiment of a battery pack circuit board with a position-variable connector of the invention;

FIG. 2(B) is a schematic view showing another preferred embodiment of a battery pack circuit board with a position-variable connector of the invention;

FIG. 3 is a schematic view showing a flowchart of the method for changing the position of the connector in the battery pack circuit board according to the invention.

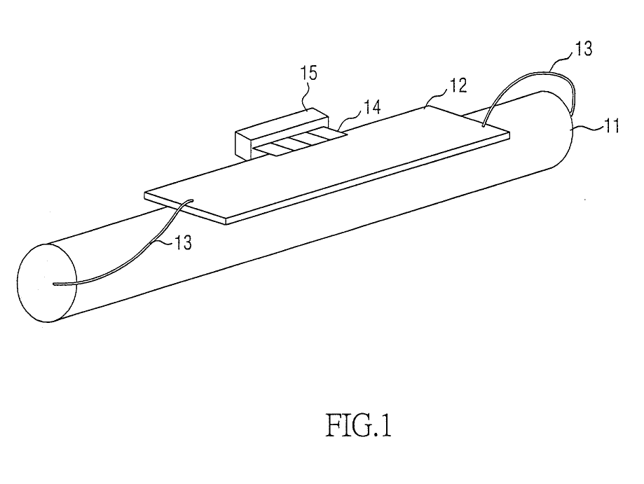

### DETAILED DESCRIPTION OF THE INVENTION

The invention of a battery pack circuit board with a position-variable connector will be apparent from the following detailed description, which proceeds with reference to the accompanying drawings, wherein the same references relate to the same elements.

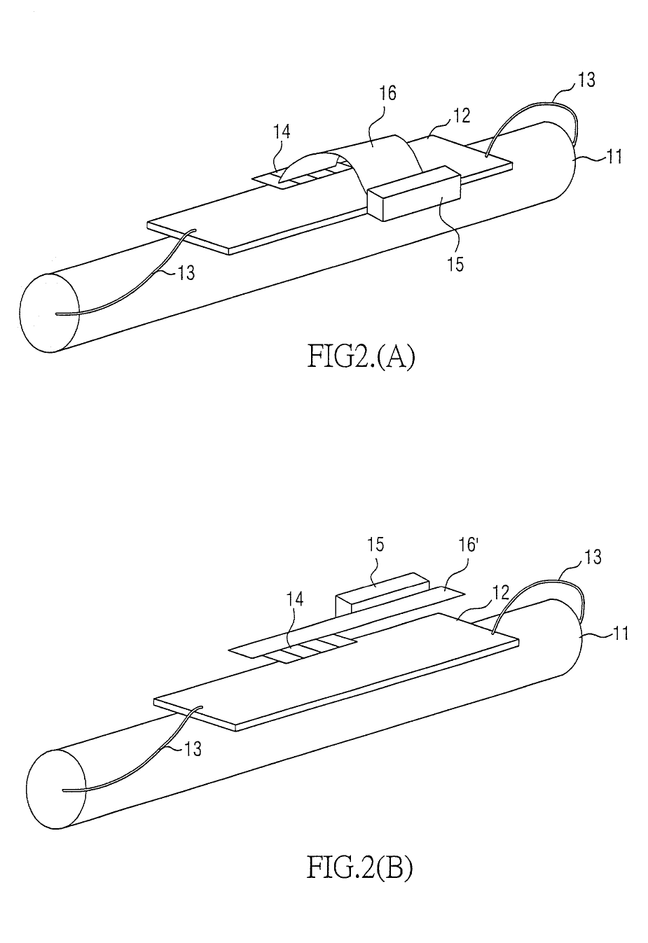

With reference to FIG. 2(A), a preferred embodiment of the battery pack circuit board 12 according to the invention electrically connects to a battery cell 11 and an electronic device (not shown). The disclosed battery pack circuit board contains an output terminal 14, a connector 15 and a connecting means 16. The circuit board 12 connects to the anode and cathode of the battery cell 11 through wires 13 and has a charging circuit and a protection circuit. The connector 15 connects to a corresponding connector on the electronic device so as to transfer the current output from the battery cell 11 to the electronic device or to charge the battery cell 11 via the electronic device.

The location of the connector 15 is designed according to the location of the corresponding connector on the electronic device. The battery pack designer can determine the location of the connector 15 relative to the circuit board 12 according to the location of the corresponding connector on the electronic device. The connector 15 is then fixed on the circuit board 12. A connecting means 16 is used to connect the output terminal 14 and the connector 15. In the current embodiment, the connecting means 16 is a flexible printed circuit (FPC). However, a skilled person in the field can make necessary and equivalent modifications to the connecting means 16. For example, the connection between the output terminal 14 and the connector 15 can be achieved using a jump wire or a printed circuit board (PCB). Furthermore, the connector 15 is not necessarily fixed on the circuit board 12, but can be fixed, for example, on the shell of the battery pack (not shown).

With reference to FIG. 2(B), in this embodiment of the invention, the connecting means 16′ is a PCB. As described above, after determining the position of the connector 15, the PCB with a proper size can be designed as needed. The PCB is then used as the connecting means 16 to connect the output terminal 14 and the connector 15.

In the prior art, when the connector of an electronic product changes its location, the corresponding connector on the battery pack circuit board has to change accordingly. In the invention, however, the battery pack circuit board with a position-variable connector uses a connecting means 16 to connect the output terminal 14 and the connector 15. Therefore, as shown in FIGS. 2(A) and 2(B), the location of the connector 15 varies, but the electronic device can use the same circuit board 12. In other words, the output terminal 14 and the connector 15 on the circuit board 12 do not have to be at the same position. Through the connecting means 16, the output terminal 14 and the connector 15 can be electrically connected. Thus, as long as the circuits on the battery pack circuit boards of different electronic products are the same, the same battery pack circuit board can be employed. The time and cost for developing new electronic devices can be decreased.

A preferred method for changing the location of the connector of the battery pack circuit board is explained as follows:

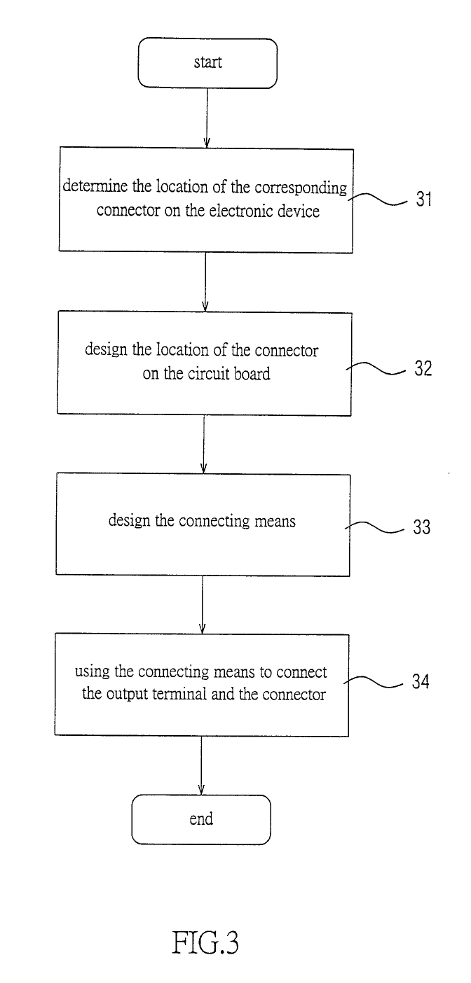

With reference to FIG. 3, the disclosed method first determines the location of the corresponding connector on the electronic device in step 31. The location of the connector 15 on the circuit board 12 is then designed according to the location of the corresponding connector on the electronic device in step 32. In step 33, a proper connecting means 16 is designed according to the relative positions of the output terminal 14 and the connector 15 on the circuit board 12, determining the material and dimension of the connecting means. Finally, the output terminal 14 and the connector 15 are connected using the connecting means 16 in step 34.

In the circuit board 12, the output terminal 14 and the connector 15 are electrically connected by the connecting means 16, so as to change the relative positions of the connector 15 and the output terminal 14. Therefore, the connector 15 can change its position in accordance with the position of the electronic device without the need to replace the originally used circuit board 12.

Certain variations would be apparent to those skilled in the art, which variations are considered within the spirit and scope of the claimed invention.

What is claimed is:

1. A battery pack circuit board electrically connecting to a battery cell and an electronic device, comprising:
a connector to connect to a corresponding connector of the electronic device;
an output terminal installed on the battery pack circuit board so as to output the electrical power of the battery cell through the battery pack circuit board; and
a connecting means electrically connecting the output terminal and the connector so that the relative position between the connector and the output terminal is variable.

2. The battery pack circuit board of claim 1, wherein the connecting means is a flexible printed circuit (FPC).

3. The battery pack circuit board of claim 1, wherein the connecting means is a jump wire.

4. The battery pack circuit board of claim 1, wherein the connecting means is a printed circuit board (PCB).

5. A method for changing the location of a connector of a battery pack circuit board, the circuit board electrically connecting to a battery cell and an electronic device and containing a connector and an output terminal, with the connector connecting to a corresponding connector on the electronic device and the output terminal installed on the circuit board for outputting the electrical power of the battery cell, the method being characterized in electrically connecting the output terminal and the connector via a connecting means so that the relative position between the connector and the output terminal is variable.

6. The method of claim 5, wherein the connecting means is a flexible printed circuit (FPC).

7. The method of claim 5, wherein the connecting means is a jump wire.

8. The method of claim 5, wherein the connecting means is a printed circuit board (PCB).

9. A circuit board connecting to an electronic device, which comprises:
a connector connecting to a corresponding connector of the electronic device;
an output terminal installed on the circuit board; and
a connecting means electrically connecting to the output terminal and the connector so that relative position between the connector and the output terminal is variable.

10. The circuit board of claim 9, wherein the connecting means is a flexible printed circuit (FPC).

11. The circuit board of claim 9, wherein the connecting means is a jump wire.

12. The circuit board of claim 9, wherein the connecting means is a printed circuit board (PCB).
